(19) United States
(12) Patent Application Publication
(10) Pub. No.: US 2017/0129620 A1
(43) Pub. Date: May 11, 2017

(54) AIRCRAFT FUEL SYSTEM

(71) Applicant: AIRBUS OPERATIONS LIMITED, Bristol (GB)

(72) Inventors: Angus MORGAN, Bristol (GB); Christopher SLACK, Bristol (GB)

(21) Appl. No.: 15/342,334

(22) Filed: Nov. 3, 2016

(30) Foreign Application Priority Data
Nov. 5, 2015 (GB) 1519562.1

(51) Int. Cl. B64D 37/20; B64D 37/34; B64D 37/04; B64D 37/02

(52) U.S. Cl. CPC B64D 37/20; B64D 37/02; B64D 37/34; B64D 37/04

(57) ABSTRACT

An aircraft fuel system has a fuel tank for containing liquid fuel, the fuel tank having a base. The aircraft fuel system also has a fuel pump for drawing liquid fuel from the fuel tank, a fuel conduit having a fuel outlet through which fuel is permitted to flow from the fuel tank, and a filter defining a filtered fuel space enclosing the fuel outlet. The fuel conduit extends between the fuel outlet and the fuel pump, and the filter extends from the base to enclose the fuel outlet. The fuel conduit extends into the filtered space and the fuel outlet faces and is spaced from the base. This helps to minimise the quantity of unusable fuel in the aircraft fuel system. The present application also relates to an aircraft wing having an aircraft fuel system, and an aircraft having an aircraft fuel system.

### RELATED APPLICATION

This application claims priority to Great Britain Patent application 1519562.1 filed Nov. 5, 2015, the entirety of which is incorporated by reference.

### FIELD OF THE INVENTION

The present invention relates to an aircraft fuel system. In particular, the present invention relates to an aircraft fuel system that helps to minimise the quantity of unusable fuel in the aircraft fuel system. The present invention also relates to an aircraft wing having an aircraft fuel system, and an aircraft having an aircraft fuel system.

### BACKGROUND OF THE INVENTION

Fuel in an aircraft is typically stored in one or more fuel tanks. Such fuel tanks are generally disposed in the interior space of the wings and fuselage of the aircraft. A fuel delivery arrangement including a fuel pump is arranged to draw fuel from the or one of the fuel tanks and provide the fuel to one or more engines.

In one arrangement, a fuel pump is disposed in the fuel tank which draws fuel from the tank and feeds it along a pipe to be used by the one or more engines.

Due to the necessary structural arrangement which results in an irregular shape of the fuel tank and the provision of structural components extending in the fuel tank, together with requirements on the size of the fuel pump to be capable of drawing a sufficient volume of fuel, there are restrictions on the location of the fuel pump in the fuel tank. For example, internal structural components restrict the location of the fuel pump. It is therefore difficult to draw all of the fuel from the fuel tank. For example, it is typically not possible to dispose the fuel pump at or near to the lowest point in the fuel tank; that is the lowest point in the fuel tank is defined as the lowest point to which fuel would flow when the aircraft is in its normal flight attitude for the fuel tank in its empty configuration. As such, there is a quantity of fuel in the aircraft that cannot be retrieved.

The fuel delivery arrangement is not able to draw all of the fuel contained in the fuel tank. This volume of fuel is therefore trapped in the fuel tank, and is not usable. This fuel is known as residual fuel. The residual fuel is excess weight carried by an aircraft which contributes to an increase in aircraft weight, a reduction in the efficiency of the aircraft, and reduces the volume of usable fuel that the aircraft is capable of carrying.

### SUMMARY OF THE INVENTION

According to one aspect of the present invention, there is provided an aircraft fuel system comprising: a fuel tank for containing liquid fuel, the fuel tank having a base, a fuel pump for drawing liquid fuel from the fuel tank, a fuel conduit having a fuel outlet through which fuel is permitted to flow from the fuel tank, and a filter defining a filtered fuel space enclosing the fuel outlet, the fuel conduit extending between the fuel outlet and the fuel pump, wherein the filter extends from the base to enclose the fuel outlet, and wherein the fuel conduit extends into the filtered space and the fuel outlet faces and is spaced from the base.

The fuel opening may be at an opposing end of the fuel conduit to the fuel pump.

The fuel pump may be outside the fuel tank.

The fuel outlet may extend parallel to the base.

With this arrangement, it is possible for the fuel level at which fuel flows along the fuel conduit to correspond with the minimum spacing between the fuel conduit and the base.

The fuel outlet may be an opening at one end of the fuel conduit.

The fuel conduit may be spaced from the base by a predefined minimum distance.

The predefined minimum distance between the fuel conduit and the base is about 10 mm.

The base may be an inner surface of the fuel tank.

The filter may be an enclosure defining the filtered fuel space.

The base may define one side of the filtered fuel space.

The enclosure may be formed by a sheet material.

The sheet material may be a gauze.

The filter may surround the fuel outlet.

The enclosure may comprise an aperture through which the fuel conduit extends into the filtered fuel space.

The total surface area of openings in the enclosure may be greater than the cross-sectional area of the fluid outlet. With this arrangement filter restrictions due to the collation of detritus is reduced.

The total surface area of openings in the enclosure may be equal to or greater than three times the cross-sectional area of the fluid outlet.

The filter may be configured to form a conductive path between the base and the fuel conduit.

The fuel conduit may extend in the fuel tank.

The fuel conduit may extend from the fuel tank.

The fuel pump may comprise an impeller, the impeller being spaced from the fuel outlet.

According to another aspect of the present invention, there is provided a fuel filter for an aircraft fuel system comprising: a mounting arrangement configured to mount the fuel filter to a base of a fuel tank, and an aperture configured to receive a fuel conduit therethrough so that a fuel outlet of the fuel conduit is received in the fuel filter.

According to another aspect of the present invention, there is provided an aircraft wing comprising the aircraft fuel system according to any one of claims 1 to 21.

According to another aspect of the present invention, there is provided an aircraft comprising the aircraft fuel system according to any one of claims 1 to 21.

### BRIEF DESCRIPTION OF THE DRAWINGS

Embodiments of the invention will now be described with reference to the accompanying drawings, in which:

FIG. 1 is a view of an aircraft;

FIG. 2 is a schematic view of part of a known aircraft fuel system including a fuel tank;

FIG. 3 is a schematic view of an aircraft fuel system according to one embodiment of the present invention;

FIG. 4 is a perspective view of a fuel conduit and filter of the aircraft fuel system shown in FIG. 3; and

FIG. 5 is a cross-sectional side perspective view of part of a fuel conduit and filter of the aircraft fuel system shown in FIG. 3.

### DETAILED DESCRIPTION OF EMBODIMENT(S)

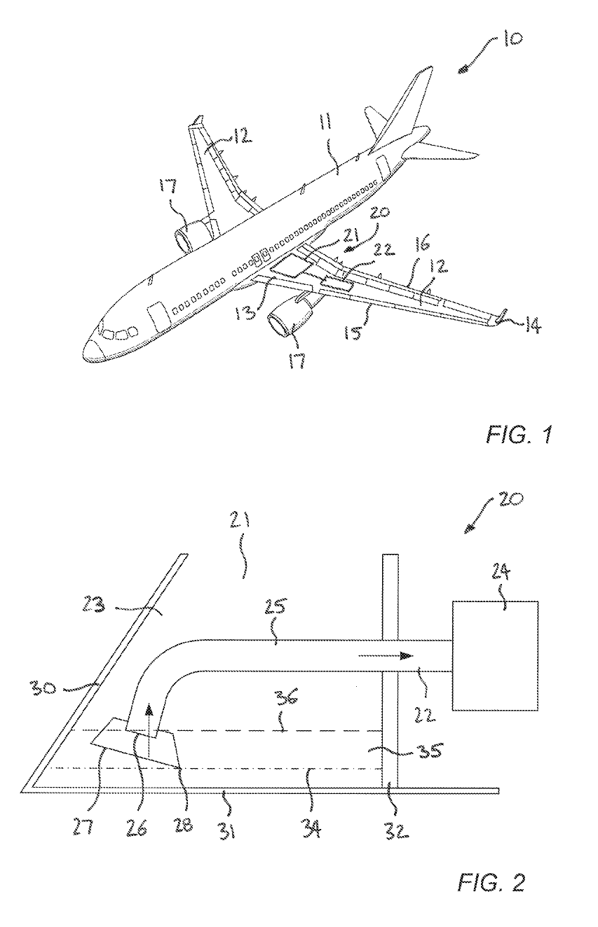

An aircraft 10 is shown in FIG. 1. The aircraft 10 includes a fuselage 11. Two wings 12 extend from the fuselage 11. It will be appreciated that the fuselage 11 and wings 12 may take a variety of different planform shapes and profiles depending on the particular application. Each wing 12 has a wing root 13 at the juncture with the fuselage 11, and a wing tip 14 at a distal end. The wing 12 has a leading edge 15 and a trailing edge 16. It will be appreciated that the structure of the wing 12 tends to incline in a spanwise direction, that is from the wing root 13 to the wing tip 14. Similarly the structure of the wing 12 tends to incline in a chordwise direction, that is from the trailing edge 16 to the leading edge 15. The aircraft 10 has two engines 17, although the number of engines may vary. Each wing 12 has one of the engines 17 mounted to the underside of the wing 12.

The engines 17 are supplied with fuel by an aircraft fuel system 20. The aircraft fuel system 20 comprises a fuel tank 21. Part of the aircraft fuel system 20 including part of the fuel tank 21 are shown schematically in FIG. 1. Typically, one or more fuel tanks 21 are located in each wing 12, and one or more fuel tanks 21 are located in the fuselage 11. Fuel contained in the or each fuel tank 21 is fed to the or each engine 17 by a fuel delivery arrangement 22.

A schematic cross-sectional profile view of part of a known arrangement of the aircraft fuel system 20 is shown in FIG. 2. The aircraft fuel system 20 includes the fuel tank 21 in the wing 12. Part of the fuel delivery arrangement 22 is also shown.

In the arrangement shown in FIG. 2, the fuel tank 21 extends in a chordwise direction, that is from trailing edge 16 to leading edge 15 (shown in FIG. 1), from left to right. However, it will be understood that FIG. 2 may also demonstrate the fuel tank extending in the spanwise direction, that is from wing root 13 to wing tip 14 (shown in FIG. 1), from left to right.

The fuel tank 21 defines a fuel containing space 23. Fuel in the fuel tank 21 flows to the fuel delivery arrangement 22 to be fed from the fuel tank 21. The fuel tank 21 is formed by structural components 30 of the aircraft 10. The structural components 30 include a lower skin 31 of the wing 12. The lower skin 31 defines a base of the fuel tank 21. Further internal structural components protrude in the wing 12. One such internal structural components 32 is shown in FIG. 2. The internal structural component 32 protrudes from the lower skin 31 of the wing 12. The internal structural component 32 in this arrangement forms a fuel barrier.

Part of the fuel delivery arrangement 22 is shown. The fuel delivery arrangement 22 comprises a fuel pump 24. The fuel pump 24 is received in the wing 12. A fuel conduit 25 extends from the fuel pump 24 along which fuel is fed from the fuel tank 21 and towards the engines 17. The fuel conduit 25 is open to the fuel containing space 23. The fuel pump 24 is operable to draw fuel from the fuel containing space 23. The fuel conduit 25 has a fuel outlet 26 through which fuel is drawn from the fuel containing space 23.

The fuel pump 24 is disposed outside the fuel containing space 23. Therefore, the fuel pump 24 is spaced from the fuel tank 21. In another arrangement, the fuel pump 24 is disposed in the fuel containing space 23.

A fuel filter 27 encloses the fuel outlet 26. The fuel filter 27 is mounted at the free end of the fuel conduit 25 to surround the fuel outlet 26. The fuel filter 27 is provided to ensure detritus in the fuel containing space 23 is not transferred to the fuel delivery arrangement 22. The fuel filter 27 is spaced from the fuel outlet 26 to minimise fuel blockage due to detritus collation.

Due to the necessary structural arrangement of the aircraft 10, together with requirements on the size of the fuel pump 12 to be capable of drawing a sufficient volume of fuel, there are restrictions on the location of the fuel pump 12. For example, internal structural components restrict the location of the fuel pump 12.

It is also necessary to provide a minimum spacing between components in the fuel containing space 23 and the outer surface of the wing 12 or fuselage 13, in this case the lower skin 31 of the wing 12, to prevent spark transfer between the component and the lower skin 31 of the wing 12 during a lightning strike, for example. Such minimum spacing is demonstrated by dot-dash line 34 in FIG. 2. A proximal edge 28 of the fuel filter 27 is therefore spaced from the lower skin 31 of the wing 12.

It will be understood that once the level of fuel falls below the fuel outlet 26, fuel will no longer be drawn through the fuel delivery arrangement 22. Due to the necessary structural arrangement of the aircraft 10, it is not possible to dispose the fuel pump 12 at the lowest point in the fuel tank 21, that is defined as the lowest point when the aircraft is in its normal flight attitude for the fuel tank in its empty configuration. It has been found that the fuel delivery arrangement 22 is not able to draw all of the fuel contained in the fuel receiving space 23. This volume of fuel is therefore trapped in the fuel tank 12, and is not usable. This fuel is known as residual fuel 35 and the extent of the residual fuel 35 is demonstrated in FIG. 2 by dashed line 36. The end of the fuel conduit 25 having the fuel outlet 26 is angled in FIG. 2 in an attempt to minimise the volume of residual fuel 35.

The residual fuel 35 is excess weight carried by an aircraft which contributes to an increase in aircraft weight 10, a reduction in the efficiency of the aircraft 10 and reduces the volume of usable fuel that the aircraft 10 is able to carry.

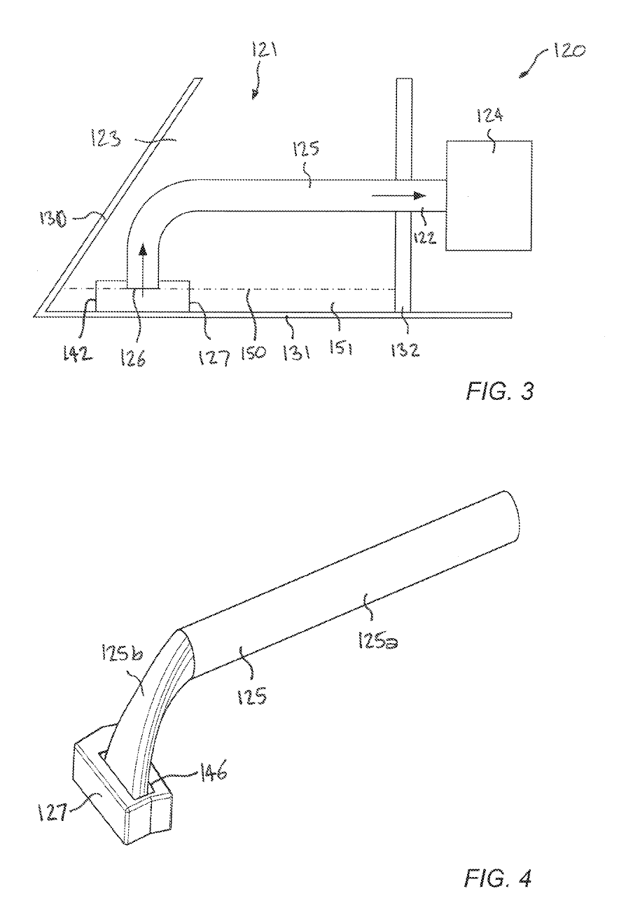

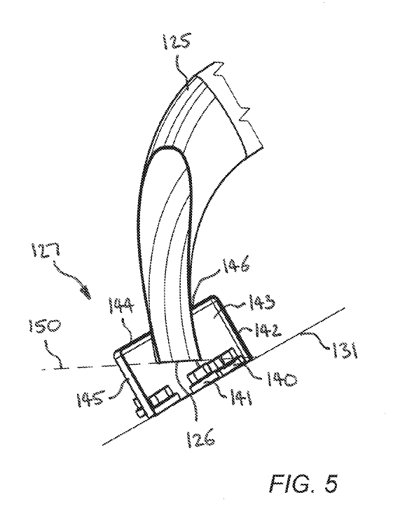

With reference to FIG. 3, FIG. 4 and FIG. 5, part of the aircraft fuel system according to the present invention is shown. In FIG. 3, a schematic cross-sectional profile view of an embodiment of part of the aircraft fuel system according to the present invention is shown. The arrangement of the fuel tank is generally the same as the fuel tank shown in FIG. 2, however the fuel delivery arrangement is different. As such, some reference numerals for corresponding features and components will be retained.

An aircraft fuel system 120 according to the present invention includes a fuel tank 121 in the wing 12. Part of a fuel delivery arrangement 122 of the aircraft fuel system 120 is also shown.

In the embodiment shown in FIG. 3, the fuel tank 121 extends in a chordwise direction, that is from trailing edge 16 to leading edge 15 (shown in FIG. 1), from left to right. However, it will be understood that FIG. 2 may also demonstrate the fuel tank extending in the spanwise direction, that is from wing root 13 to wing tip 14 (shown in FIG. 1), from left to right.

The fuel tank 121 defines a fuel containing space 123. Fuel in the fuel tank 121 flows to the fuel delivery arrangement 122 to be fed from the fuel tank 21. The fuel tank 121 is formed by structural components 130 of the aircraft 10. The structural components 130 include a lower skin 131 of the wing 12. The lower skin 131 defines a base of the fuel tank 121. Further internal structural components protrude in the wing 12. One such internal structural components 132 is shown in FIG. 3. The internal structural component 132 protrudes from the lower skin 131 of the wing 12. The internal structural component 132 in this embodiment forms a fuel barrier.

Part of the fuel delivery arrangement 122 is shown. The fuel delivery arrangement 122 comprises a fuel pump 124. The fuel pump 124 is received in the wing 12. A fuel conduit 125 extends from the fuel pump 124 along which fuel is fed from the fuel tank 121 and towards the engines 17. The fuel conduit 125 is open to the fuel containing space 123. The fuel pump 124 is operable to draw fuel from the fuel containing space 123. The fuel conduit 125 has a fuel outlet 126 through which fuel is drawn from the fuel containing space 123.

The fuel pump 124 has an impeller (not shown). The impeller acts as a fuel drawing element. The impeller is in the fuel pump. Therefore, the impeller is spaced from the fuel outlet 126.

The fuel pump 124 is disposed outside the fuel containing space 123. Therefore, the fuel pump 124 is spaced from the fuel tank 121. In another embodiment, the fuel pump 124 is disposed in the fuel containing space 123. The fuel conduit 125 provides for the fuel outlet 126 to be provided in a preferable location, irrespective of the location of the fuel pump 124. The fuel conduit 125 also provides for the fuel pump 124 to be disposed outside the fuel containing space 123.

A fuel filter 127 encloses the fuel outlet 126. The fuel filter 127 and part of the fuel conduit 125 are shown in FIG. 4 and FIG. 5. The fuel filter 127 is provided to ensure detritus in the fuel containing space 123 is not transferred to the fuel delivery arrangement 122. The fuel filter 127 is spaced from the fuel outlet 126 to minimise restriction of the effective filter flow area due to detritus collation. The fuel filter 127 is configured to provide an effective flow area which is greater than the cross-sectional area of the fuel outlet 126, preferably an effective flow area which is at least three times greater than the cross-sectional area of the fuel outlet 126.

The fuel filter 127 extends from the lower skin 131, the lower skin 131 acting as the base of the fuel tank 121. The fuel filter 127 is mounted to the base by a mounting arrangement 140. The mounting arrangement 140 in the present embodiment comprises bolt receiving apertures (not shown) and bolts 141. Other mounting arrangements are anticipated.

The fuel filter 127 defines an enclosure 142. The enclosure 142 upstands from the lower skin 131. The enclosure 142 defines a filtered fuel space 143. The enclosure 142 has a top wall 144 and a peripheral side wall 145. It will be understood that the shape and size of the fuel filter 127 may differ. The top wall 144 is spaced from the lower skin 131. In the present embodiment, the lower skin 131 defines one side of the filtered fuel space 143.

The fuel filter 127 is formed by a sheet material. The sheet material defines the enclosure 142. The sheet material is a gauze. That is the sheet material is formed by a plurality of intertwined strands which define a plurality of small openings. Alternative arrangements are possible to form the fuel filter 127. For example, the sheet material may be a planar material with a plurality of perforations formed therethrough. The fuel filter is fuel permeable. That is, fuel is able to pass through the filter. However, detritus is prevented from passing into the filtered fuel space 143. The fuel filter is formed from a wire mesh in the present embodiment, although alternative configurations are envisaged.

An aperture 146 is formed through the enclosure 142. The aperture 146 is configured to receive the fuel conduit 125 therethrough. That is, the fuel conduit 125 extends into the filtered fuel space 143. The edges of the aperture 146 locate against the fuel conduit 125. The fuel outlet 126 is open to the filtered fuel space 143. Therefore, fuel in the fuel containing space 123 must pass through the fuel filter 127 to flow along the fuel delivery arrangement 122. The fuel filter 127 is fixedly mounted at the free end of the fuel conduit 125 to surround the fuel outlet 126.

The fuel outlet 126 is spaced from the lower skin 131. This provides a gap to provide a sufficient flow rate through the fuel outlet 126. A proximal edge of the fuel outlet 126 is therefore spaced from the lower skin 31 of the wing 12. The total surface area of openings in the enclosure 142 is equal to or greater than five times the flow area of the fluid outlet 126.

In FIG. 3 and FIG. 4, the plane of the fuel outlet 126 extends parallel to the plane of the surface of fuel in the fuel tank when the aircraft is in its normal flight attitude for the fuel tank in its empty configuration. This helps minimise the minimum required distance between the fuel conduit 125 and the lower skin 131 and so minimises the volume of residual fuel 151, as represented by dash-dot line 150. In FIG. 5, the plane of the fuel outlet 126 extends at an acute angle to the lower skin 131. The fuel conduit 125 comprises a first section 125a which extends from the fuel pump 122. The first section 122 protrudes into the fuel tank 121. A second section 125b of the fuel conduit 125 extends from the first section 125a. The second section 125b has an arcuate arrangement to allow the fuel conduit to be brought into closer relationship with the lower skin 131 and so minimise the volume of residual fuel 151.

With the arrangement described above it is not necessary for the fuel filter 127 to be disposed between the fuel outlet 126 and the lower skin 31 of the wing 12.

Although the invention has been described above with reference to one or more preferred embodiments, it will be appreciated that various changes or modifications may be made without departing from the scope of the invention as defined in the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. An aircraft fuel system comprising:
a fuel tank configured to contain liquid fuel, the fuel tank having a base,
a fuel pump configured to drawing the liquid fuel from the fuel tank,
a fuel conduit having a fuel outlet through which the liquid fuel flows from the fuel tank, and
a filter defining a filtered fuel space enclosing the fuel outlet,
wherein the fuel conduit extends between the fuel outlet and the fuel pump, the filter extends from the base to enclose the fuel outlet, and the fuel conduit extends into the filtered space and the fuel outlet faces and is spaced from the base.

2. The aircraft fuel system according to claim 1, wherein the fuel outlet is at an opposing end of the fuel conduit to the fuel pump.

3. The aircraft fuel system according to claim 1, wherein the fuel pump is outside the fuel tank.

4. The aircraft fuel system according to claim 1, wherein the fuel outlet extends parallel to the base.

5. The aircraft fuel system according to claim 1, wherein the fuel outlet is an opening at one end of the fuel conduit.

6. The aircraft fuel system according to claim 1, wherein the fuel conduit is spaced from the base by a predefined minimum distance.

7. The aircraft fuel system according to claim 6, wherein the predefined minimum distance between the fuel conduit and the base is about 10 mm.

8. The aircraft fuel system according to claim 1, wherein the base is an inner surface of the fuel tank.

9. The aircraft fuel system according to claim 1, wherein the filter is an enclosure defining the filtered fuel space.

10. The aircraft fuel system according to claim 9, wherein the base defines one side of the filtered fuel space.

11. The aircraft fuel system according to claim 9, wherein the enclosure is formed by a sheet material.

12. The aircraft fuel system according to claim 11, wherein the sheet material is a gauze.

13. The aircraft fuel system according to claim 9, wherein the filter surrounds the fuel outlet.

14. The aircraft fuel system according to claim 13, wherein the enclosure comprises an aperture through which the fuel conduit extends into the filtered fuel space.

15. The aircraft fuel system according to claim 9, wherein the total surface area of openings in the enclosure is greater than the cross-sectional area of the fluid outlet.

16. The aircraft fuel system according to claim 15, wherein the total surface area of openings in the enclosure is equal to or greater than three times the cross-sectional area of the fluid outlet.

17. The aircraft fuel system according to claim 1, wherein the filter is configured to form a conductive path between the base and the fuel conduit.

18. The aircraft fuel system according to claim 1, wherein the fuel conduit extends in the fuel tank.

19. The aircraft fuel system according to claim 1, wherein the fuel conduit extends from the fuel tank.

20. The aircraft fuel system according to claim 1, wherein the fuel pump comprises an impeller, the impeller being spaced from the fuel outlet.

21. An apparatus comprising a fuel filter for an aircraft fuel system and a fuel conduit, the fuel filter comprising:
a filtered space,
a mounting arrangement configured to mount the fuel filter to a base of a fuel tank, and
an aperture through which the fuel conduit extends into the filtered space so that a fuel outlet of the fuel conduit is received in filtered space,
wherein the fuel outlet is configured to face and be spaced from the base of the fuel tank.

22. An aircraft wing comprising the aircraft fuel system according claim 1.

23. An aircraft comprising the aircraft fuel system according to claim 1.

24. An aircraft fuel system comprising:
a fuel tank in a wing of the aircraft, wherein a base of the fuel tank is a portion of a lower skin of the wing;
a fuel conduit extending from the fuel tank and form at least a portion of a fuel passage extending to a fuel pump, the fuel conduit including a fuel outlet within the fuel tank and facing the base; and
a filter extending from the base and enclosing the fuel outlet, wherein the filter and the portion of the lower skin define a filtered fuel space enclosing the fuel outlet.
